(19) United States
(12) Patent Application Publication
(10) Pub. No.: US 2024/0419888 A1
(43) Pub. Date: Dec. 19, 2024

(54) METHOD FOR PROVIDING WEB FONT SERVICE THROUGH MESSAGING SERVICE APPLICATION AND SERVER PROVIDING THE SAME

(71) Applicant: SANDOLL INC., Seoul (KR)

(72) Inventors: Young Ho Yun, Seoul (KR); Hyun Jin Yun, Seoul (KR); Dong Hyuk Park, Seoul (KR)

(73) Assignee: SANDOLL INC., Seoul (KR)

(21) Appl. No.: 18/740,769

(22) Filed: Jun. 12, 2024

(30) Foreign Application Priority Data
Jun. 15, 2023 (KR) 10-2023-0077075
Apr. 24, 2024 (KR) 10-2024-0054445

(51) Int. Cl. G06F 40/109; H04L 9/40; H04L 51/00

(52) U.S. Cl. CPC G06F 40/109; H04L 51/00; H04L 63/08

(57) ABSTRACT

A method for providing a web font messaging service through a messaging service application according to the present invention includes: transmitting, by a message transmitter, a message to at least one receiver through a first server of the application; requesting, by the message transmitter and the receiver, a second server for a font file; and performing, by the application, text rendering on a screen by using a subset web font file received in response to the request, in which the second server confirms dedicated authentication keys of the message transmitter and the receiver, generates the subset web font file, and transmits the generated subset web font file to the message transmitter and the receiver.

### CROSS-REFERENCE TO RELATED APPLICATION(S)

This application claims benefit of priority to Korean Patent Application No. 10-2023-0077075 filed on Jun. 15, 2023 and Korean Patent Application No. 10-2024-0054445 filed on Apr. 24, 2024 in the Korean Intellectual Property Office, the disclosure of which is incorporated herein by reference in its entirety.

### BACKGROUND

### 1. Field

The present invention relates to a method for providing a web font service through a messaging service application and a server providing the same.

### 2. Description of Related Art

A web font is a technology for using a font file to express a text in an application. As platforms for accessing applications such as mobile and tablet applications become more diverse, the use of the web font is increasing. Accordingly, there is a need to develop technologies to service the web font within an application screen that may meet the diverse needs of customers in providing the web font.

In this regard, in a related art for the web font, a first subset font and a second subset font are separately provided in providing the web font, and corresponding font information is provided only on the web page based on such separate provision.

Such a method that includes separately providing the subset fonts in providing the web font according to the related art (a web font server providing subset fonts and a web font system including the same (Korean Patent Application No. 10-2012-0050470)) may become a factor that decreases a web font rendering speed on the application screen, which may cause various problems.

For example, when the web font rendering speed is decreased, a phenomenon in which a text that has been invisible appears (flash of invisible text (FOIT)) and a phenomenon in which a text changes while blinking (flash of unstyled text (FOUT)) occur, which may cause inconvenience to customers who use the application.

Furthermore, as the mobile messenger market expands, users prefer interfaces that reflect individuality rather than uniform application interfaces. Therefore, it is necessary to establish and provide a web font service to express individuality of the users in messaging applications.

Specifically, there is a need for a method for providing a web font service that may protect a copyright of a font itself while meeting various customer needs and may improve a web font rendering speed in a messaging application screen.

### SUMMARY

An object of the present invention is to propose a method for providing a web font service in response to a web font request from a customer using a messaging service of an application.

More specifically, an object of the present invention is to propose a method for providing a font, which allows a primary user providing a messaging service, and a transmitter and a receiver exchanging messages to use a web font in an application provided by a server of the primary user.

Another object of the present invention is to propose a method for providing a web font service, which increases a rendering speed of an application screen by significantly reducing time consumption due to a use of a web font by each customer, and significantly reduces a possibility of leakage of the web font by providing a part of the web font.

According to an exemplary embodiment of the present invention, a method for providing a web font messaging service through a messaging service application, executed by at least one processor, includes: transmitting, by a message transmitter, a message to at least one receiver through a first server of the application; requesting, by the message transmitter and the receiver, a second server for a font file; and performing, by the application, text rendering on a screen by using a subset web font file received in response to the request, in which the second server confirms dedicated authentication keys of the message transmitter and the receiver, generates the subset web font file, and transmits the generated subset web font file to the message transmitter and the receiver.

The method may further include: confirming, by the second server, web font service usage information of a first user including a list of available fonts; generating and storing a dedicated authentication key of the first user based on the usage information; providing, to the first user, the generated authentication key and a web font software development kit (SDK); and adding, by the first user, font-related information to a messaging transmission and reception format in the first server based on provided information and reflecting the addition in the application provided by the first server.

The web font SDK may be inserted for each of one or more operating systems (OSs) or for each of one or more development languages into the application provided by the first server by using the generated dedicated authentication key of the first user.

The message received through the first server of the messaging service application may include web font information selected by the message transmitter and information of the dedicated authentication key of the message transmitter.

The second server may confirm the authentication key of the message transmitter including authentication key validity period information for the requests from the message transmitter and the receiver using the application provided by the first server, generate the subset web font file based on the confirmation, and transmit the generated subset web font file to a terminal of the at least one receiver.

According to another exemplary embodiment of the present invention, a method for providing a web font through a messaging service application includes: confirming, by a second server, web font service usage information of the application and generating an application user dedicated authentication key; confirming, by the application, the application user dedicated authentication key and requesting the second server for a font for text rendering by using a dedicated web font SDK; and performing, by the application, the text rendering in a user terminal by using a received subset web font file, in which the second server confirms validity of web font request information including the application user dedicated authentication key, generates the subset web font file, and transmits the generated subset web font file to the web font SDK.

The second server may confirm a dedicated authentication key of a first user for user authentication, and generate the application user dedicated authentication key including authentication key validity period information based on the confirmation.

In the requesting of the second server for the font, the web font SDK may have a cache function for the latest used font, the function may include a function of reusing the latest used subset web font file or using a subset web font file including a frequently used text according to a request font text.

The second server may provide a subset web font file for a frequently used text for a requested text and may provide a subset web font file including an expected response text calculated using an artificial intelligence (AI)-based chatbot.

The present invention may be implemented by a computer-readable recording medium storing a program for executing the above-described methods.

### BRIEF DESCRIPTION OF DRAWINGS

FIG. 1 is an illustrative diagram illustrating a process of providing a web font messaging service according to an exemplary embodiment of the present invention;

FIG. 2 is a flowchart illustrating the process of providing the web font messaging service according to an exemplary embodiment of the present invention;

FIG. 3 is a conceptual diagram illustrating a service usage information registration process for using the web font messaging service according to an exemplary embodiment of the present invention;

FIG. 4 is a timing chart illustrating the process of providing the web font messaging service according to an exemplary embodiment of the present invention;

FIG. 5 is an illustrative diagram illustrating an authentication and service provision process for providing the web font messaging service according to an exemplary embodiment of the present invention;

FIG. 6 is a timing chart illustrating the authentication and service provision process for providing the web font messaging service according to an exemplary embodiment of the present invention;

FIG. 7 is an illustrative diagram illustrating a method for providing a web font messaging service according to another exemplary embodiment of the present invention; and

FIG. 8 is a diagram illustrating implementation of a computing device of a server that provides a web font service according to an exemplary embodiment of the present invention.

### DETAILED DESCRIPTION

The following description exemplifies only a principle of the present invention. Therefore, those skilled in the art may implement the principle of the present invention and invent various apparatuses included in the spirit and scope of the present invention although not clearly described or illustrated in the present specification. In addition, it is to be understood that all conditional terms and exemplary embodiments mentioned in the present specification are obviously intended only to allow those skilled in the art to understand a concept of the present invention in principle, and the present invention is not limited to exemplary embodiments and states particularly mentioned as such.

The objects, features, and advantages described above will become more obvious from the following detailed description provided in relation to the accompanying drawings. Therefore, those skilled in the art to which the present invention pertains may easily practice the technical spirit of the present invention.

Further, in describing the present invention, in the case in which it is determined that a detailed description of the well-known technology related to the present invention may unnecessarily make the gist of the present invention unclear, it will be omitted. Hereinafter, exemplary embodiments of the present invention will be described in detail with reference to the accompanying drawings.

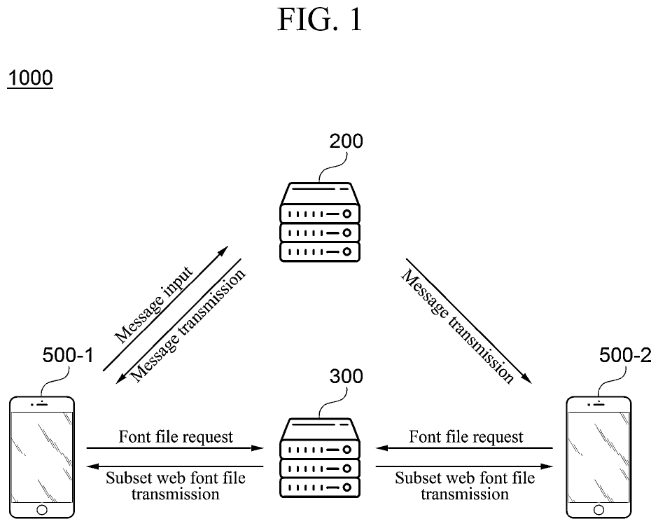

Hereinafter, a process of providing a web font messaging service through an application according to the present exemplary embodiment will be described with reference to FIG. 1.

FIG. 1 is an illustrative diagram illustrating the process of providing the web font messaging service according to the exemplary embodiment of the present invention.

In the present exemplary embodiment, a web font service system 1000 may include a transmitter terminal 500-1 and a receiver terminal 500-2 that receive, through a first server 200 providing a messaging service and a second server 300 providing a web font service, the messaging service in which a web font is applied.

In the present exemplary embodiment, the first server 200 may correspond to a service provider that provides the messaging service to the transmitter terminal 500-1 and the receiver terminal 500-2, and the second server 300 may correspond to a provider that provides the web font service to the first server 200 and the user terminals 500 using the first server 200.

The second server 300 may generate and store various font files and subset web fonts, and may provide various types of font information to those requesting fonts.

Specifically, the second server 300 may provide web font information and a subset web font file in response to a web font request from the user terminals 500 including the transmitter terminal 500-1 and the receiver terminal 500-2, and may perform a web font service authentication procedure, a web font service registration procedure, and the like.

The second server 300 may generate and store unique authentication information of the first server 200 and the user terminals 500 using the first server 200 to provide the web font service.

A source font storage module in the second server 300 may store and manage a source font file for each font and may transmit an encrypted file of a corresponding font to a font providing module to provide the web font service in a case where there is no font file requested by the transmitter terminal 500-1 and the receiver terminal 500-2 in the font providing module.

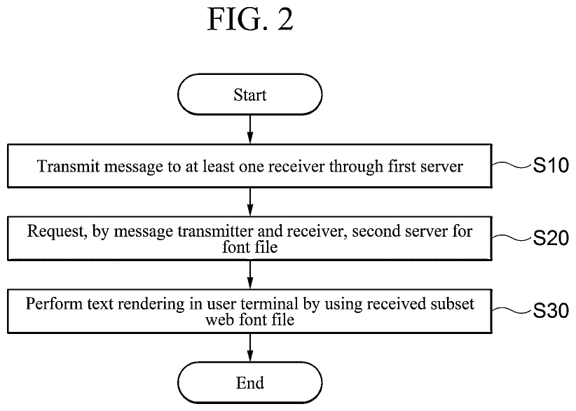

Hereinafter, the process of providing the web font messaging service according to the present exemplary embodiment will be described with reference to FIG. 2.

FIG. 2 is a flowchart illustrating the process of providing the web font messaging service according to an exemplary embodiment of the present invention.

In the present exemplary embodiment, the transmitter terminal 500-1 may transmit a message to at least one receiver terminal 500-2 through the first server 200 (S10).

Each of the transmitter terminal 500-1 and the receiver terminal 500-2 receiving the message transmitted by the transmitter terminal 500-1 from the first server 200 may request the second server 300 for a font file selected by the transmitter terminal 500-1 (S20). The second server 300 may confirm authentication information for the requests from the transmitter terminal 500-1 and the receiver terminal 500-2 and generate a subset web font file. At this time, the authentication information may include a primary authentication value for providing a primary available font list of the first server 200 and a secondary authentication value for a font selected from the available font list.

At this time, the transmitter terminal 500-1 may request the second server 300 for the font file by re-receiving a message including the authentication information from the first server 200 for the transmitted message. The second server 300 may confirm that the first server 200 has completed a service usage information registration process and authentication for the web font-based messaging service through the primary authentication value in the authentication information, and may confirm that the users of the first server 200 have requested the font selected from among the provided fonts through the secondary authentication value.

Once the authentication is completed, the second server 300 may transmit the generated subset web font file to the transmitter terminal 500-1 and the receiver terminal 500-2, and each of the transmitter terminal 500-1 and the receiver terminal 500-2 performs text rendering on the message by using the received subset web font file (S30).

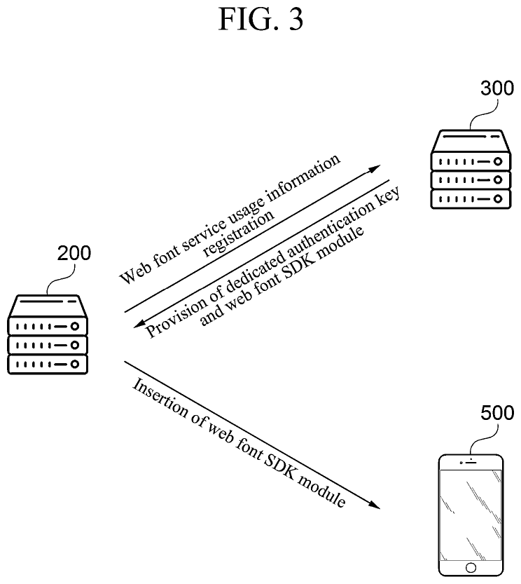

Hereinafter, a web font messaging service usage information registration process according to the present exemplary embodiment will be described in more detail with reference to FIG. 3.

FIG. 3 is a conceptual diagram illustrating the service usage information registration process for using the web font messaging service according to an exemplary embodiment of the present invention.

In the present exemplary embodiment, the second server 300 may receive a request for the web font service in the messaging service of the first server 200 and register usage information in the font providing module in the second server 300. Here, the usage information may include, as product information, at least one of a list of fonts to be used by the first server 200, identification information of the messaging service to which a font is to be applied, or an IP for testing.

The first server 200 may individually purchase each web font at a predetermined price, or purchase a license for a predetermined period of time at a predetermined price. Alternatively, the first server 200 may purchase a subscription that allows free use of a specific range of web font sets.

A web font purchasing method is not limited to the above-described examples, and the web fonts may be purchased and used in various ways depending on a sales method of the second server 300.

The second server 300 may include the font providing module, which is a module for providing a font in conjunction with the messaging service of the first server 200, and the source font storage module that manages source information of fonts.

Therefore, the font providing module may store a font file in advance and generate and provide a subset of glyphs included in a message of the messaging service. In a case where the corresponding font file does not exist, the font providing module may request the source font storage module for the source font file.

The source font storage module may transmit an encrypted file of the requested font to the font providing module, and the font providing module may decrypt and store the received encrypted font file.

Meanwhile, the font providing module and the source font storage module are not limited to be separate components. For example, the source font storage module may exist as a database of the font providing module. Alternatively, the source font storage module may be implemented by an external server, and the font providing module may receive a font file from the external server and provide the web font service described below. In this case, the source font storage module may be independent of the second server 300 and may be separately configured as a server of font rights holders who hold the rights to the fonts.

The second server 300 may generate and store authentication information for authenticating the first server 200. The second server 300 may generate a dedicated authentication key including the authentication information, and a web font software development kit (SDK) according to registered service usage information of the first server 200, and provide the dedicated authentication key and the web font SDK to the first server 200.

The web font SDK may be a set of tools for developing a program to execute a specific function on a user terminal in conjunction with the font providing module described above in a form that may be installed in a messaging application. In the present exemplary embodiment, the web font SDK may include a library, an application programming interface (API), or the like for executing a function of requesting the font providing module of the second server 300 for a subset web font together with the authentication information by identifying a font included in a message and glyphs to which the font is applied.

Accordingly, the SDK (515) provided by the second server 300 may be provided for each operating system (OS) of the user terminal or for each development language capable of interfacing with the messaging service.

Next, the first server 200 may add font-related information to a messaging transmission and reception data format and implement a service environment by using an SDK module 515 implemented by inserting the web font SDK provided from the second server 300 into an application 510. At this time, the first server 200 may provide a more stable service by inserting the web font SDK (515) using the dedicated authentication key for the first server 200.

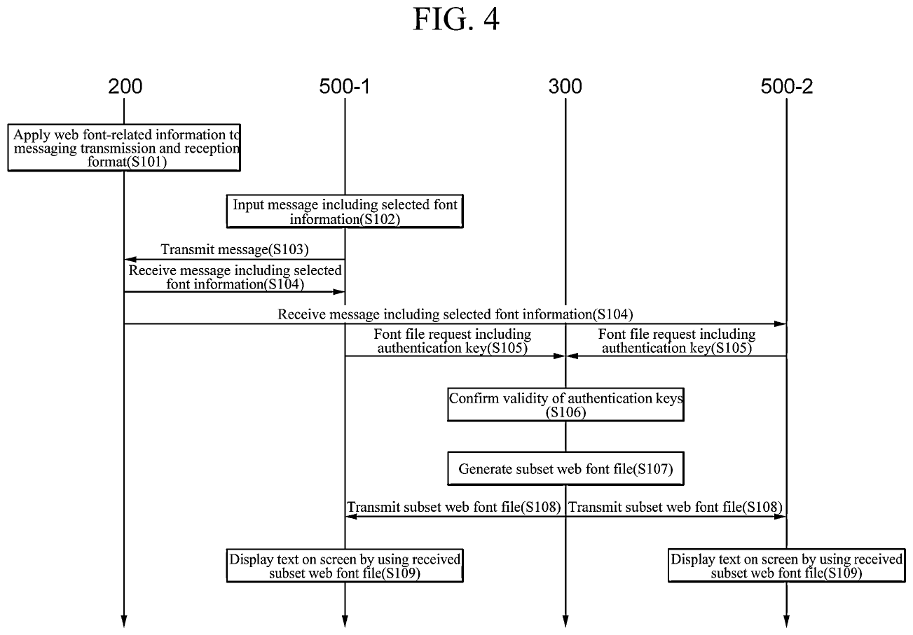

Hereinafter, the process of providing the web font messaging service according to the present exemplary embodiment will be described with reference to FIG. 4.

FIG. 4 is a timing chart illustrating the process of providing the web font messaging service according to an exemplary embodiment of the present invention.

In FIG. 4, for convenience of explanation, a process of transmitting and receiving information between the transmitter terminal 500-1 and the receiver terminal 500-2 is described, focusing on the second server 300.

Referring to FIG. 4, the first server 200 may apply web font-related information in advance to the messaging transmission and reception data format (S101) as described with reference to FIG. 3.

Next, the transmitter terminal 500-1 may input a message including font information selected to be used through the application (S102) and transmit the message to the first server 200 (S103).

The transmitter terminal 500-1 and the receiver terminal 500-2 may receive the message delivered to the first server 200 (S104). Specifically, the received message may include an authentication key and the applied web font information.

The transmitter terminal 500-1 and the receiver terminal 500-2 receiving the above message may transmit a font file request to the second server 300 (S105).

Specifically, the font file request may include identification information of the font used, text information of the message, and the received authentication key.

The second server 300 may confirm whether or not the authentication keys of the transmitter terminal 500-1 and the receiver terminal 500-2 are valid for the font file request (S106). Here, the second server 300 may confirm at least one of a transmitter ID, whether the requested font matches an available font list, or a validity period included in the authentication key to confirm whether or not the authentication keys are valid.

In a case where the second server 300 determines that the font file request is a normal font request through the procedure of confirming whether or not the authentication key is valid, the second server 300 generates an optimized subset web font based on web font request information (S107). Here, the subset web font may refer to a font file having a more compressed size by providing only a font for glyphs to be used to improve dynamic loading performance. A subset web font file may be data generated based on the text information in the web font request information, and may also include an alternative font subset in a case where an alternative font is included.

Specifically, the second server 300 may generate a subset web font by performing font subsetting based on text information in the web font request information and a pre-stored web font.

Further, the second server 300 may provide a faster service for the font file request by storing the generated subset web font for a predetermined period of time. At this time, the predetermined period of time may be determined based on a frequently used message depending on a characteristic of the messaging application, or may vary depending on a size of the subset web font.

Next, the second server 300 may transmit the subset web font file generated based on the web font request information to the transmitter terminal 500-1 and the receiver terminal 500-2 (S108).

In a case where the second server 300 receives a web font request identical to the previously requested information from the transmitter terminal 500-1 and the receiver terminal 500-2, that is, in a case where rendering may be performed using glyphs in a stored subset web font file, the second server 300 may skip the generating (S107) described above and directly transmit the already generated and stored subset web font file to the transmitter terminal 500-1 and the receiver terminal 500-2.

The transmitter terminal 500-1 and the receiver terminal 500-2 receiving the subset web font file from the second server 300 may display a text on a screen by using the received subset web font file (S109).

According to the present invention, a customer-specific web font service is provided through the second server 300, so that a font desired by the user may be easily applied to the application 510 in the user terminal 500 along with the messaging service of a first user.

In addition, according to the present invention, the second server 300 may provide a subset web font file to which alternative font information for a selected font is applied in a case where a change in service usage information, such as expiration of a usage period of the service provided by the first server 200 or a change in the version of the messaging application, occurs, thereby improving stability of a subset-based web font.

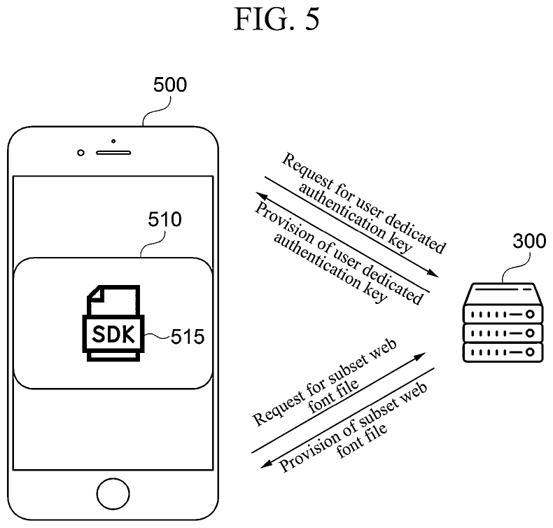

Hereinafter, a method for providing the web font messaging service according to the present exemplary embodiment will be described with reference to FIG. 5.

FIG. 5 is an illustrative diagram illustrating an authentication and service provision method for providing the web font messaging service according to an exemplary embodiment of the present invention.

In the present exemplary embodiment, in a case where the user wants to use the web font service by running the application 510 of the first server 200 using the user terminal 500, the SDK module 515 in the application 510 may request the second server 300 for a user dedicated authentication key, and the second server 300 may provide the user dedicated authentication key to the user terminal 500.

Then, the user terminal 500 may request the second server 300 for a subset web font file based on the provided dedicated authentication key information, receive a web font, and perform rendering based on the received subset web font file to display a text on the screen of the application 510.

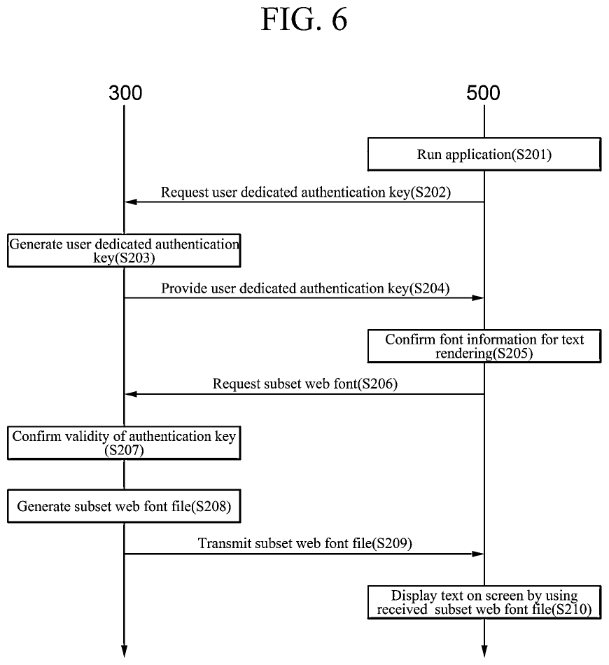

Hereinafter, the method for providing the web font messaging g service according to the present exemplary embodiment will be described with reference to FIG. 6.

FIG. 6 is a timing chart illustrating the method for providing the web font messaging service according to an exemplary embodiment of the present invention.

Referring to FIG. 6, the user may run the application 510 provided by the first server 200 using the user terminal 500 (S201).

Next, the user terminal 500 may request the second server 300 for the user dedicated authentication key through the run application 510 (S202). Here, information requested as the dedicated authentication key may include at least one of a user ID, a list of fonts available to the user, or an authentication key validity period.

The second server 300 may generate the requested authentication key (S203) and provide the authentication key to the user terminal 500 (S204).

The user terminal 500 may confirm font information for rendering a text included in a message through the web font SDK module 515 (S205) and request the second server 300 for a subset web font file based on the authentication key (S206). The request information for the web font file may include text data for the requested web font and the authentication key required for an authentication procedure to use the web font service.

Further, the web font SDK module 515 according to the present exemplary embodiment may have a cache function to temporarily store the latest used font. As the web font SDK module 515 has the cache function, the latest used subset web font may be reused, and a subset web font for a text of a frequently used phrase (for example, expressions for greetings or responses) may be temporarily stored in the user terminal 500 and used without an additional request.

Therefore, in the confirming of the font information (S205), in a case where rendering of the font and text included in the font request may be performed using a subset web font received as a response from the font providing module within a predetermined period, the web font SDK 515 may provide the stored subset web font to the user terminal 500 without an additional request process to display the text in a desired font.

The second server 300 may confirm validity of the received authentication key for the web font file request of the user terminal 500 (S207), generate the subset web font file (S208), and provide the subset web font file to the user terminal 500 (S209). In a case where the transmitter ID is not identified as a result of confirming the validity of the authentication key, the list of available fonts does not match the requested font, or the validity period of the font has expired, the request may be determined to be invalid.

In a case where it is determined that the font file request is an invalid and abnormal access, the second server 300 may transmit an error response to the user terminal 500, and notify the first server 200 of the abnormal access. At this time, the second server 300 may transmit the error response, and the web font SDK module 515 may render the text to display the text in a default font in order to transmit and receive the message of the user.

In a case where it is determined that the font request is a normal font request as a result of confirming the validity of the authentication key, the second server 300 may generate the optimized subset web font file based on the web font request information.

Specifically, the second server 300 may generate the subset web font file by performing font subsetting based on the text information in the web font request information and the pre-stored web font as described above.

In addition, in the process of generating the subset web font, the second server 300 may generate and provide a subset web font for a frequently used text in advance, and may provide a subset web font including an expected response. To this end, the second server 300 may extract statistical information of a usage frequency from a short message text and continuously update a frequently used response text having a predetermined size.

Furthermore, the second server 300 may generate an additional subset by predicting the next word or sentence based on requested glyphs using a generative language model. Accordingly, the second server 300 may provide, to the user terminal 500, a subset web font that includes a font for glyphs of an expected response text in a subset corresponding to the glyphs of the requested text.

The user terminal 500 may perform rendering by using the subset web font file received from the second server 300 and display the text on the screen of the application 510 (S210).

According to the present invention described above, text information may be generated by collecting texts in the application 510 for each font, and the web font SDK module may be used based on the text information, thereby significantly reducing time consumption due to the use of a web font when performing rendering on the application 510.

In addition, an optimized subset web font may be used when providing the web font information, thereby reducing a capacity of the web font.

Further, as the capacity of the web font is reduced, a download time for the web font may be shortened, and network traffic and costs may be reduced.

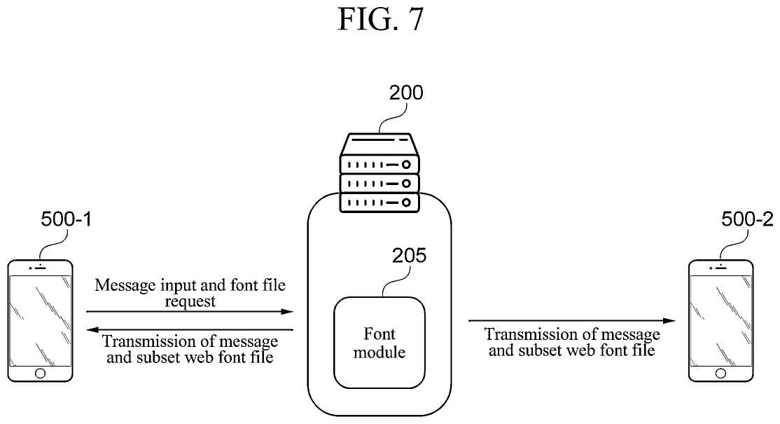

Hereinafter, a process of providing a web font messaging service according to another exemplary embodiment will be described with reference to FIG. 7.

FIG. 7 is an illustrative diagram illustrating a method for providing a web font messaging service according exemplary embodiment of the present to an additional invention.

In the above-described exemplary embodiment, the first server 200 and the second server 300 providing the web font service in the process of transmitting and receiving a message between the transmitter terminal 500-1 and the receiver terminal 500-2 have been described as separate components. However, the first server 200 and the second server 300 may be implemented as one server.

Specifically, a second server 300 may be implemented as a single font module 205 within a first server 200 and may provide a font for a message transmitted to or received from the first server 200 in response to a request from a user terminal 500.

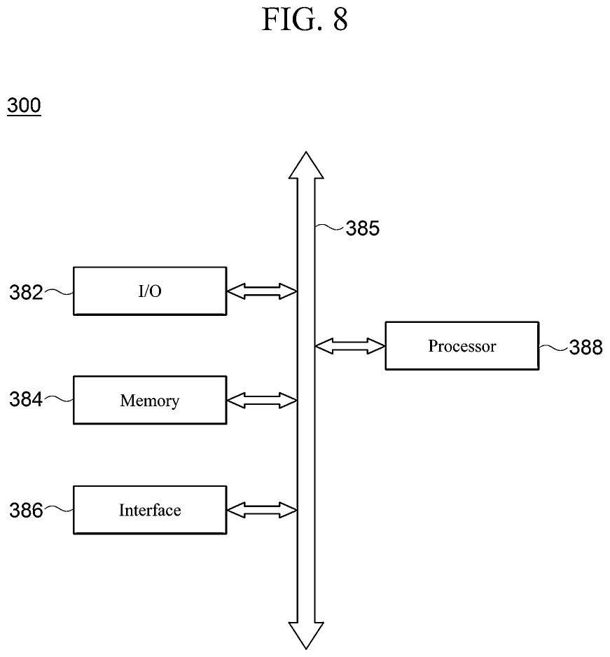

Hereinafter, specific hardware implementation of the second server 300 as a computing device that provides the web font messaging service according to the present exemplary embodiment will be described with reference to FIG. 8.

Referring to FIG. 8, the second server 300 may be implemented in the form of a computing device in some exemplary embodiments of the present invention. One or more of the modules included in the second server 300 may be implemented on a general-purpose computing processor, and may thus include a processor 388, an input/output (I/O) 382, a memory 384, an interface 386, and a bus 385. The processor 388, the I/O 382, the memory 384, and/or the interface 386 may be coupled to one another through the bus 385. The bus 385 may correspond to a path through which data are migrated.

Specifically, the processor 388 may include at least one of a central processing unit (CPU), a micro processor unit (MPU), a micro controller unit (MCU), a graphics processing unit (GPU), a microprocessor, a digital signal processor, a microcontroller, an application processor (AP), or logic elements capable of executing similar functions thereof.

The I/O 382 may include at least one of a keypad, a keyboard, a touch screen, or a display device. The memory 384 may store data, a program, and/or the like.

The interface 386 may execute a function of transmitting data to or receiving data from a communication network. The interface 386 may be wired or wireless. For example, the interface 386 may include an antenna or a wired or wireless transceiver. The memory 384 may be a volatile operating memory that improves the operation of the processor 388 and protects personal information, and may further include a high-speed DRAM and/or SRAM.

Further, the memory 384 may store programming and data configurations that provide the functions of some or all of the modules described herein. For example, the memory 384 may store logic to perform selected aspects of the above-described method.

A program or application may be loaded with a set of instructions including the steps of performing the above-described method stored in the memory 384, and the processor may perform each step.

Furthermore, various exemplary embodiments described herein may be implemented in computer-readable recording medium using, for example, software, hardware, or a combination thereof.

According to a hardware implementation, the exemplary embodiments described herein may be implemented using at least one of application specific integrated circuits (ASICs), digital signal processors (DSPs), digital signal processing devices (DSPDs), programmable logic devices (PLDs), field programmable gate arrays (FPGAS), processors, controllers, micro-controllers, microprocessors, and electric units for performing other functions. In some cases, the exemplary embodiments described in the present specification may be implemented as a control module itself.

According to a software implementation, exemplary embodiments such as procedures and functions described in the present specification may be implemented as separate software modules. Each of the software modules may perform one or more functions and operations described in the specification. A software code may be implemented as a software application written in a suitable programming language. The software code may be stored in a memory module and executed by a control module.

Specifically, the technical spirit of the present invention has been described only by way of example hereinabove, and the present invention may be variously modified, altered, and substituted by those skilled in the art to which the present invention pertains without departing from essential features of the present invention.

According to the present invention, when providing the web font messaging service, the dedicated authentication keys of the message transmitter and the receiver may be confirmed, and a subset web font file to be reflected in the screen of the application provided by the first server based on the confirmation may be used, thereby providing an optimized service for each user using a web font.

Further, according to the present invention, the user dedicated web font SDK may be used to perform user authentication of the application and generate the subset web font when providing the web font service, thereby significantly reducing time consumption due to the use of a web font when performing rendering on the screen of the application, reducing a capacity of the web font, shortening a download time for the web font, and reducing network traffic and costs.

Accordingly, the exemplary embodiments disclosed in the present invention and the accompanying drawings are provided in order to describe the technical spirit of the present invention rather than limiting the technical spirit of the present invention, and the scope of the present invention is not limited by these exemplary embodiments and the accompanying drawings. The scope of the present invention should be interpreted by the following claims and it should be interpreted that all spirits equivalent to the following claims fall within the scope of the present invention.

What is claimed is:

1. A method for providing a web font messaging service through a messaging service application, executed by at least one processor, the method comprising:
transmitting, by a message transmitter, a message to at least one receiver through a first server of the application;
requesting, by the message transmitter and the receiver, a second server for a font file; and
performing, by the application, text rendering on a user screen by using a subset web font file received in response to the request,
wherein the second server confirms dedicated authentication keys of the message transmitter and the receiver, generates the subset web font file, and transmits the generated subset web font file to the message transmitter and the receiver.

2. The method of claim 1, further comprising:
confirming, by the second server, web font service usage information of a first user including a list of available fonts;
generating and storing a dedicated authentication key of the first user based on the usage information; providing, to the first user, the generated authentication key and a web font software development kit (SDK); and
adding, by the first user, font-related information to a messaging transmission and reception format in the first server based on provided information and reflecting the addition in the application provided by the first server.

3. The method of claim 2, wherein the web font SDK is provided for each of one or more operating systems (OSs) or for each of one or more development languages in the application provided by the first server by using the generated dedicated authentication key of the first user.

4. The method of claim 1, wherein the message received through the first server of the messaging service application includes web font information selected by the message transmitter and information of the dedicated authentication key of the message transmitter.

5. The method of claim 1, wherein the second server confirms the authentication key of the message transmitter including authentication key validity period information for the requests from the message transmitter and the receiver using the application provided by the first server, generates the subset web font file based on the confirmation, and transmits the generated subset web font file to a terminal of the at least one receiver.

6. A method for providing a web font through a messaging service application, the method comprising:
confirming, by a second server, web font service usage information of the application and generating an application user dedicated authentication key;
confirming, by the application, the application user dedicated authentication key and requesting the second server for a font for text rendering by using a web font SDK module; and
performing, by the application, the text rendering in a user terminal by using a received subset web font file,
wherein the second server confirms validity of web font request information including the application user dedicated authentication key, generates the subset web font file, and transmits the generated subset web font file to the web font SDK module.

7. The method of claim 6, wherein the second server confirms a dedicated authentication key of a first user for user authentication, and generates the application user dedicated authentication key including authentication key validity period information based on the confirmation.

8. The method of claim 6, wherein in the requesting of the second server for the font, the web font SDK module temporarily stores a latest used font.

9. The method of claim 6, wherein the second server provides the subset web font file including an additional font for expected glyphs calculated using a generative model for a requested text.

10. A computing device comprising:
a processor; and
a memory communicating with the processor,
wherein the memory stores instructions for causing the processor to perform operations,
the operations include an operation of transmitting, by a message transmitter, a message to at least one receiver through a first server of a messaging application, an operation of requesting, by the message transmitter and the receiver, a second server for a font file, and an operation of performing, by the application, text rendering on a user screen by using a subset web font file received in response to the request, and
the second server confirms dedicated authentication keys of the message transmitter and the receiver, generates the subset web font file, and transmits the generated subset web font file to the message transmitter and the receiver.

11. A computing device comprising:
a processor; and
a memory communicating with the processor,
wherein the memory stores instructions for causing the processor to perform operations,
the operations include an operation of confirming, by a second server, web font service usage information of a messaging application and generating an application user dedicated authentication key, an operation of confirming, by the application, the application user dedicated authentication key and requesting the second server for a font for text rendering by using a web font SDK module, and an operation of performing, by the application, the text rendering in a user terminal by using a received subset web font file, and
the second server confirms validity of web font request information including the application user dedicated authentication key, generates the subset web font file, and transmits the generated subset web font file to the web font SDK module.

12. A computer-readable recording medium storing a program for executing the method according to claim 1.
